(19) United States
(12) Patent Application Publication
(10) Pub. No.: US 2014/0137538 A1
(43) Pub. Date: May 22, 2014

(54) Fast Response Bypass Engine

(71) Applicant: United Technologies Corporation, (US)

(72) Inventor: James W. Fuller, Amston, CT (US)

(73) Assignee: UNITED TECHNOLOGIES CORPORATION, Hartford, CT (US)

(21) Appl. No.: 13/678,974

(22) Filed: Nov. 16, 2012

(51) Int. Cl. F02K 3/02

(52) U.S. Cl. CPC F02K 3/025
USPC 60/204; 60/262; 60/224

(57) ABSTRACT

A gas turbine engine has a compressor, a fan for delivering air into the compressor and into a bypass duct, a combustion section and a turbine section. A control for the gas turbine engine is programmed to change a fueling level and position at least one effector that may be moved to unique positions in a coordinated fashion upon receipt of a command to change thrust. The thrust provided by the engine is changed without a reduction in an airflow stability margin compared to a thrust change commanded only by a fueling change. Some aspects of the positioning are transitory.

### BACKGROUND

This application relates to a control for a gas turbine engine which changes thrust upon receipt of a command to change thrust more rapidly than in the prior art.

Gas turbine engines are known, and typically include a fan delivering air into both a bypass duct outwardly of a core engine and into a compressor in the core engine. Air in the compressor is passed downstream into a combustor section where it is mixed with fuel and ignited. Products of this combustion pass downstream over turbine rotors, driving them, and in turn drive the compressor and fan. It is common for engines to have more than one turbine driving connected compressor or fan components to allow these components to rotate at different speeds. Recently some engines include a gear reduction between a compressor and the fan, such that a single turbine can drive the two at distinct speeds. With the gear reduction, the fan has become larger, and the bypass flow has become larger, increasing propulsive efficiency.

Engines on aircraft desirably have a fast response to a command to change the thrust from the engine. Typically, thrust is sustainably changed by sending increased fuel to the combustor section such that turbine rotors rotate at a higher speed, and the fan and compressors are driven at a higher speed also. In this manner, more air is moved, more air and fuel are combusted, and the overall thrust is increased.

However, with the larger fans, the inertia of the fan which must be overcome to change the thrust also increases. It is sometimes difficult to overcome this inertia as rapidly as would be desired. The need to maintain smooth and unstalled airflow in the fans and compressors limits the amount of torque a fan driving turbine can be allowed and thus limits a rate of fan speed and thrust change. Particularly, torque is related to pressure ratio and the maximum pressure ratio across these components that is conducive to stable airflow is a function of component speed and other factors.

Transient changes in thrust are also possible by adjusting airfoil vane angles, flow areas, and valves so as to change the rotary kinetic energy of the rotating components.

### SUMMARY

In a featured embodiment, a gas turbine engine has a compressor, a fan for delivering air into the compressor and into a bypass duct, a combustion section and a turbine section. A control for the gas turbine engine is programmed to change a fueling level and position at least one effector that may be moved to unique positions in a coordinated fashion upon receipt of a command to change thrust, such that the thrust provided by the engine is changed without a reduction in loss of an airflow stability margin compared to a thrust change commanded only by a fueling change, and with some aspects of the positioning being transitory.

In another embodiment according to the previous embodiment, the compressor section includes a high pressure compressor and a low pressure compressor. The turbine section includes a low pressure turbine rotor driving the low pressure compressor and fan.

In another embodiment according to any of the previous embodiments, a gear reduction is between the fan and the low pressure turbine.

In another embodiment according to any of the previous embodiments, a variable inlet vane is positioned intermediate the fan and compressor. The variable inlet vane is the at least one effector positioned to achieve the increase in thrust.

In another embodiment according to any of the previous embodiments, a variable nozzle is positioned to change a cross-sectioned area of the bypass duct. The variable nozzle is also positioned to change the thrust provided in combination with positioning the variable inlet vane.

In another embodiment according to any of the previous embodiments, a variable nozzle is positioned to change a cross-sectioned area of the bypass duct. The variable nozzle is the at least one effector positioned to change the thrust.

In another embodiment according to any of the previous embodiments, fan speed changes more slowly than thrust.

In another embodiment according to any of the previous embodiments, fan speed initially moves in a direction opposite the change in thrust.

In another embodiment according to any of the previous embodiments, the loss of air flow stability margin is only partially mitigated.

In another featured embodiment, according to any of the previous embodiments, a method of operating a gas turbine engine includes receiving a command to change thrust. A fueling level is changed. At least one effector is positioned to a unique position in a coordinated fashion, such that the thrust provided by the engine is changed without a reduction in an airflow stability margin compared to a thrust change commanded only by a fueling change, and with some aspects of the positioning being transitory.

In another embodiment according to the previous embodiment, a variable inlet vane is at least one effector and includes the step of positioning the variable inlet vane to achieve the thrust change.

In another embodiment according to any of the previous embodiments, a variable nozzle is also positioned to change the thrust in combination with positioning the variable inlet vane.

In another embodiment according to any of the previous embodiments, a variable nozzle is the at least one effector and includes the step of positioning the variable nozzle to change the thrust provided.

In another embodiment according to any of the previous embodiments, the nozzle is moved toward an open position to increase thrust.

In another embodiment according to any of the previous embodiments, a gear reduction is provided between the fan and a turbine rotor driving the fan.

In another embodiment according to any of the previous embodiments, the fan delivers air into a compressor, and into a bypass duct.

In another embodiment according to any of the previous embodiments, a fan speed changes more slowly than if only fueling were changed in response to the command to change thrust.

In another embodiment according to any of the previous embodiments, the fan speed initially moves in a direction opposite to a normal movement in response to a fueling change to achieve a change in thrust.

These and other features may be best understood from the following drawings and specification.

### BRIEF DESCRIPTION OF THE DRAWINGS

FIG. 1 shows a gas turbine engine.

FIG. 2 is a flow chart.

### DETAILED DESCRIPTION

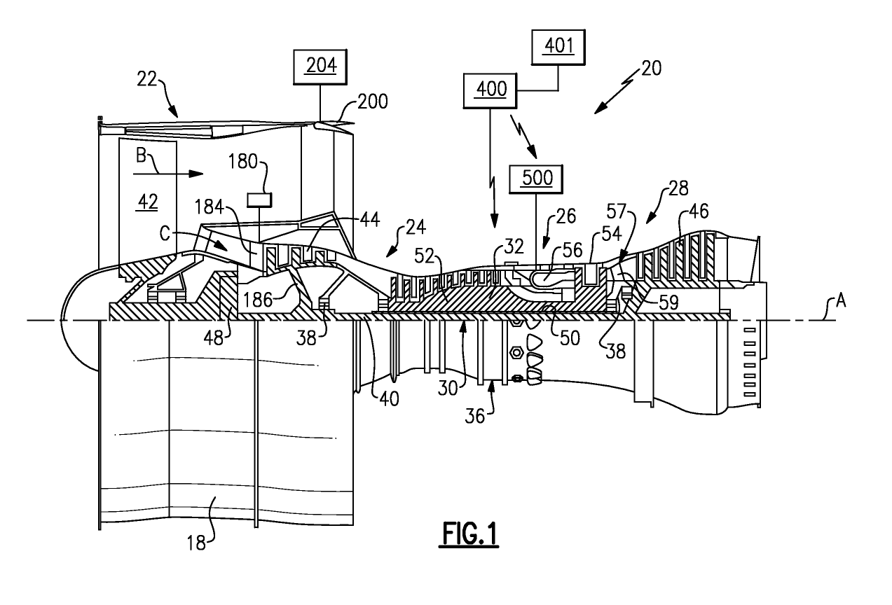

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath B in a bypass duct within a nacelle 18 and also the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. Geared architecture 48 essentially provides a gear reduction. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tambient deg R)/(518.7)̂^{0.5}]. The “Low corrected fan tip speed” as disclosed herein according to one non-limiting embodiment is less than about 1150 ft/second.

The gas turbine engine 20 is provided with controls and features to optimize the provision of an increase in thrust. Typically, fuel flow rate to the combustor 56 is adjusted as a primary means of control. The example engine 20 also includes a variable fan exhaust area 200, inlet guide vanes to the low and high compressors and various bleed valves (not shown) that are typically correspondingly adjusted to optimize a steady state tradeoff of efficiency, durability, and airflow stability margins. More generally, the engine may also include other effectors in the fan stream B, for example fan inlet guide vanes and fan blade pitch angle, that change the amount of torque the low turbine must supply to turn the fan at a given speed thus changing the work the fan does on the airstream.

Thus an actuator (not shown) selective moves a valve in the fuel pump 500 system to increase the fuel flow rate to the combustor 56.

An actuator 180 selectively drives a control to position a compressor inlet guide vane 184, which is just forward of the forward most low compressor rotor 186

An actuator 204 can actuate a variable area nozzle 200 mounted on nacelle 18 to restrict the flow area 202 of the bypass duct, and increase thrust.

The nozzle 200, and actuator 204 are generally as known, however, operating them or other fan stream B effectors to provide immediate thrust increase is novel. Starting from steady operation at a given thrust opening fan nozzle 200 area will simultaneously increase the thrust, increase the fan loading, and cause low rotor speed to decelerate. Thus fan spool rotary kinetic energy is being exchanged for thrust.

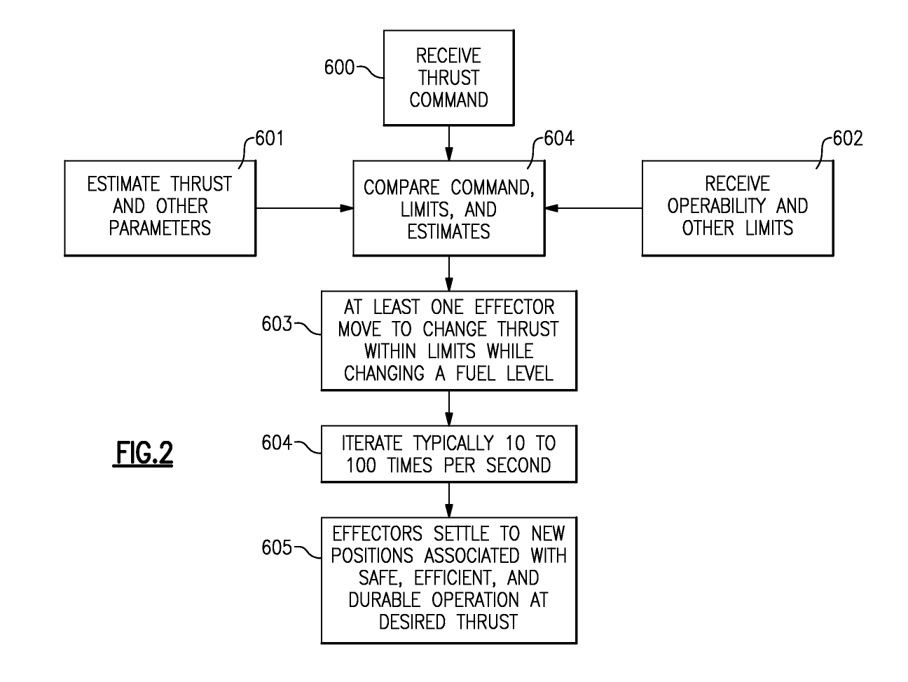

A control 400 for the engine is illustrated schematically in FIG. 1. A method of control is described below with reference to FIG. 2. When the control receives a request to increase thrust, such as from the throttle 401 in the cockpit, the control may do several things relatively quickly. Typically a controlling valve in the fuel pump system 500 is adjusted to increase fuel flow rate. This causes fan speed, thrust, and high spool speed begin to increase with varying dynamics. High compressor outlet pressure also increases, faster than its speed, driving the high pressure compressor 52 toward stall, which is undesirable. To avoid stall, fuel flow rate is typically held below a threshold that varies with a high spool speed thus limiting the rate at which thrust can be increased. As the high spool speed nears its new steady state, the airflow stability margin is restored, at a higher pressure ratio. Increasing thrust with fuel flow is sustainable, but its rate is limited because it decreases airflow stability margin transitorily.

Thrust can also be changed by a fan stream effector. As one example, the amount of thrust delivered can be increased by opening the fan nozzle 200. This consequently causes the fan speed to decelerate, the pressure between the high and low turbine to increase, and the high spool speed to increase. The latter two effects drive the high compressor away from stall. Because the fan speed is decreasing, thrust can only be temporarily changed this way. Since the high compressor is being driven away from stall, the associated rate of thrust change is not limited by this factor. Increasing thrust by controlling fan nozzle 200 can quickly change thrust because it makes the airflow more stable, but is unsustainable. Increasing thrust with fuel flow is sustainable but must be rate limited for airflow stability.

The table summarizes the associated effects of increasing thrust using different control strategies. The table also applies to thrust decreases, but with the actions and effects reversed. Thrust can be increased by increasing fuel flow alone, increasing nozzle area alone, or both. The associated effects vary with how the thrust is increased. Some effects increasing thrust and some decreasing it. When the control actions of increasing fuel flow and opening fan nozzle are combined, effects that move in the same direction, with either control action alone, are reinforced, and effects move in different directions are determined by relative mix of fuel flow and fan area changes.

| | | | High | | |
|---|---|---|---|---|---|
| Control | | | spool | High stall | Dynamic |
| action | Fan speed | Thrust | speed | margin | nature |
| Increase | increases | increases | increases | decreases | sustainable |
| fuel flow | | | | | |
| only | | | | | |
| Increase | decreases | increases | Increases | increases | transitory |
| fan nozzle | | | | | |
| area only | | | | | |

A novelty of this invention compared to typical fuel flow only control, is a multivariable control law that coordinates the variation of fuel flow and fan area in a manner that increases the rate of thrust change while mitigating the decrease in airflow stability margin. A fuel flow rate can be increased faster than is typical because increasing fan area in a coordinated fashion mitigates the loss of airflow stability margin. To increase thrust, fan nozzle 200 would initially open and later may partially close. The coordinated net effects will be a weighted sum of the effects of using fuel alone and using the fan nozzle 200 alone. Compared to using fuel flow alone, thrust and high spool speed increase faster, airflow stability loss is less, and the fan speed accelerates less quickly. Compared to changing the nozzle area alone, the fan speed does not drop thus producing a sustainable thrust change. Those skilled the art will know that vane angles 184 and other fan stream B effectors may also be coordinated with nozzle area and fuel flow to further enhance transient performance.

Although the example concerns thrust increases, those skill in art will know the coordination fan nozzle, fuel flow, and other effectors also applies to thrust decreases. In thrust decreases the fan and low compressor airflow stability margins are typically reduced, limiting the rate of thrust change. When the multivariable control logic uses the fan nozzle 200 in a coordinated manner, airflow stability loss is mitigated and thrust can thus be changed more quickly.

The control 400 may be part of the FADEC (Full Authority Digital Electronic Controller), and would typically be a multivariable control that can respond to the commands to control not only the components 184 and 200, but may also increase fuel, vanes and other effectors to more quickly change thrust without stalling the fan or compressors.

It would be desirable to have an onboard model or estimator software which would estimate the amount of thrust the engine is creating, or a thrust surrogate, that is independent of the fan speed. Also, existing software has been programmed to recognize airflow stability margins for the fan and the compressors, and these margins may be programmed into the control of the overall system. Other safety, operability and durability parameters may also limit or control how much the components such as the nozzle and variable vane are controlled.

The control may coordinate the operation of the fan 42 and various engine actuators to transitionally decrease or increase a rotary kinetic energy of the fan in the early portion of a fast response to a thrust increase or decrease command, and begin to change the fan speed and the fan thrust with consequential increase (or decrease) of the pressure between the high and low turbines which also decreases (or increases) the load on the high turbine. Further, the torque can be changed to cause a relative acceleration or deceleration of a speed of the high pressure spool.

The control may also hold various other performance, operability, safety and durability goals and limits, including limits on fan speed changes and limits on using the various airflow effectors such as components 200 and 184.

It is desirable to carefully coordinate all of the energy conversion with other engine responses. As an example, the control 400 may provide for coordinated and simultaneous fan energy conversion, off-loading of the high spool to allow it to accelerate more quickly, fuel flow and speed increases, and limiting a transitory fan speed droop.

FIG. 2 is a flow chart of the control. When the control receives a thrust command (step 600), the control will compare that command, estimate a thrust to be achieved, and other parameters as mentioned above (step 601). In addition, the control will receive operability limits and other limits (step 602).

The control will position at least one effector to change the thrust within limits, while also changing a fueling level (step 603). The control will iterate this process rapidly (for example, 10 to 100 times per second).

Eventually the effectors will move to a new position, and a new desired thrust will be achieved under safe, efficient, and sustainable operation conditions (step 605).

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a compressor;
a fan for delivering air into said compressor and into a bypass duct;
a combustion section and a turbine section; and
a control for said gas turbine engine, programmed to change a fueling level and position at least one effector that may be moved to unique positions in a coordinated fashion upon receipt of a command to change thrust, such that the thrust provided by the engine is changed without a reduction in loss of an airflow stability margin compared to a thrust change commanded only by a fueling change, and with some aspects of the positioning being transitory.

2. The engine as set forth in claim 1, wherein said compressor section includes a high pressure compressor and a low pressure compressor, and said turbine section includes a low pressure turbine rotor driving said low pressure compressor and fan.

3. The engine as set forth in claim 2, wherein there being a gear reduction between said fan and said low pressure turbine.

4. The engine as set forth in claim 1, wherein a variable inlet vane is positioned intermediate said fan and said compressor, and said variable inlet vane is said at least one effector which is positioned to achieve the increase in thrust.

5. The engine as set forth in claim 4, wherein a variable nozzle is positioned to change a cross-sectioned area of the bypass duct, and the variable nozzle is also positioned to change the thrust provided in combination with positioning said variable inlet vane.

6. The engine as set forth in claim 1, wherein a variable nozzle is positioned to change a cross-sectioned area of the bypass duct, and the variable nozzle is said at least one effector positioned to change the thrust.

7. The engine as set forth in claim 1, wherein fan speed changes more slowly than thrust.

8. The engine as set forth in claim 1, wherein fan speed initially moves in a direction opposite the change in thrust.

9. The engine as set forth in claim 1, where the loss of air flow stability margin is only partially mitigated.

10. A method of operating a gas turbine engine:
receiving a command to change thrust, and changing a fueling level and positioning at least one effector to a unique position in a coordinated fashion, such that the thrust provided by the engine is changed without a reduction in an airflow stability margin compared to a thrust change commanded only by a fueling change, and with some aspects of the positioning being transitory.

11. The method as set forth in claim 10, wherein a variable inlet vane is at least one effector and including the step of positioning the variable inlet vane to achieve the thrust change.

12. The method as set forth in claim 11, wherein a variable nozzle is also positioned to change the thrust in combination with positioning said variable inlet vane.

13. The method as set forth in claim 10, wherein a variable nozzle is the at least one effector and including the step of positioning the variable nozzle to change the thrust provided.

14. The method as set forth in claim 13, wherein said nozzle is moved toward an open position to increase thrust.

15. The method as set forth in claim 10, wherein a gear reduction is provided between said fan and a turbine rotor driving said fan.

16. The method as set forth in claim 15, wherein said fan delivers air into a compressor, and into a bypass duct.

17. The method as set forth in claim 16, wherein a fan speed changes more slowly than if only fueling were changed in response to the command to change thrust.

18. The method as set forth in claim 17, wherein said fan speed initially moves in a direction opposite to a normal movement in response to a fueling change to achieve a change in thrust.
